(19) United States
(12) Patent Application Publication
(10) Pub. No.: US 2026/0187835 A1
(43) Pub. Date: Jul. 2, 2026

(54) AUTOMATIC OPTICAL PRESCRIPTION DETECTION

(71) Applicant: Bytedance Technology Ltd., Grand Cayman (KY)

(72) Inventors: Chien Hung Lu, Los Angeles, CA (US); Bowei Zhang, Los Angeles, CA (US); Runyu Liu, Los Angeles, CA (US)

(21) Appl. No.: 19/003,176

(22) Filed: Dec. 27, 2024

(51) Int. Cl. G06T 7/73; G06T 7/00

(52) U.S. Cl. CPC G06T 7/74; G06T 7/0002; G06T 2207/30196

(57) ABSTRACT

A method for automatically detecting an optical prescription of an eyeglass lens includes emitting illumination light from a plurality of illumination light sources toward an eyeglass lens. Via a camera, the positions of one or more glints caused by the illumination light are detected on a surface of the eyeglass lens. A plurality of match loss values are calculated that quantify differences between the detected glint positions on the surface of the eyeglass lens, and reference glint positions that correspond to a plurality of different reference optical prescriptions. Based on the match loss values, a reference optical prescription is selected as being a best match for the detected glint positions. The set of one or more optical parameters corresponding to the selected reference optical prescription are output.

### BACKGROUND

Mixed reality (MR) applications, which can include augmented reality (AR) and virtual reality (VR), often employ the use of head-worn devices to provide the user with imagery that combines with, or replaces, the physical world. An accurate presentation of the virtual imagery to the user's eye(s) relies on various aspects, including knowledge of the projection optics and characteristics/location of the user's eye(s).

### SUMMARY

A method for automatically detecting an optical prescription of an eyeglass lens includes emitting illumination light from a plurality of illumination light sources toward an eyeglass lens. Via a camera, the positions of one or more glints caused by the illumination light are detected on a surface of the eyeglass lens. A plurality of match loss values are calculated that quantify differences between the detected glint positions on the surface of the eyeglass lens, and reference glint positions that correspond to a plurality of different reference optical prescriptions. Based on the match loss values, a reference optical prescription is selected as being a best match for the detected glint positions. The set of one or more optical parameters corresponding to the selected reference optical prescription are output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system used to detect the optical prescription of an eyeglass lens.

FIGS. 2A and 2B schematically illustrate the detection of glints caused by reflection of illumination light off surfaces of an eyeglass lens.

FIGS. 3A and 3B illustrate examples of detected glint positions corresponding to different reference eyeglass prescriptions.

FIG. 4 schematically illustrates calculating a match loss value based on detected glint positions and reference glint positions.

FIG. 5 schematically illustrates calculating first and second sets of match loss values based on detected glint positions from first and second cameras.

FIG. 6 schematically illustrates applying a tilt adjustment and a translation adjustment to detected glint positions.

FIGS. 7A and 7B schematically illustrate selection of a reference optical prescription based on a corresponding match loss value.

FIG. 8 illustrates an example method for automatically detecting an optical prescription of an eyeglass lens.

FIG. 9 schematically shows an example computing system.

### DETAILED DESCRIPTION

The present disclosure relates to methods for automatically determining the optical prescription of an eyeglass lens. For instance, this may be done in the context of head-mounted displays (HMDs) used to present virtual imagery to the user's eyes, and/or other suitable computing devices utilizing eye-tracking technology. More specifically, the method described herein enables the detection and analysis of glint positions, or reflections, generated by illuminating an eyeglass lens, allowing for the determination of optical parameters such as diopter power and astigmatism without the need for manual input from the user.

In conventional eye-tracking scenarios, the presence of an eyeglass lens introduces challenges, as the lens's refractive properties can distort the path of light and thereby interfere with eye-tracking accuracy, and/or distort virtual imagery presented to the user's eye via a near-eye display. Current solutions often rely on a human user manually providing information relating to their optical prescription—e.g., by inputting relevant optical parameters by hand, and/or by scanning a barcode on an eyeglass box that specifies details of the eyeglass prescription. However, such methods introduce inefficiencies and potential inaccuracies, particularly when the user-provided prescription includes errors or does not fully align with the lens's actual manufactured specifications. The disclosed techniques overcome these limitations by automatically estimating the optical prescription through real-time analysis of glint positions.

As will be described in more detail below, according to the present disclosure, illumination light is emitted from multiple illumination light sources toward an eyeglass lens. The illumination light interacts with the surface of the eyeglass lens, producing one or more glints, or points of reflection, on the surface of the lens. These glints are subsequently detected by a camera positioned to capture images of the eyeglass lens. Once the glint positions are detected, the system calculates a plurality of match loss values. Each match loss value represents a quantitative difference between the detected glint positions and different sets of reference glint positions. These reference positions correspond to various predefined reference optical prescriptions, each defined by a unique set of optical parameters. Based on the calculated match loss values, the computing system selects a reference optical prescription with a match loss value that satisfies a match threshold, indicating a potential match for the detected glint positions. Finally, the system outputs a set of one or more optical parameters corresponding to this selected reference prescription, including parameters such as diopter power and astigmatism.

This automatic determination of optical prescription provides a more efficient and accurate method for configuring eye-tracking systems in scenarios where a user is wearing eyeglasses, reducing the reliance on manual input and enhancing the user experience. For instance, the techniques discussed herein may be used to tailor the presentation of virtual imagery to account for the optical parameters of the user's prescription, improving human/computer interaction without requiring manual user input to provide their prescription details. Additionally, or alternatively, the techniques discussed herein may improve the accuracy of an eye-tracking process, by enabling the direction of the user's gaze to be estimated after accounting for optical distortion caused by the user's eyeglasses. This has the result of improving human-computer interaction, enabling the computer to more accurately detect and respond to the user's gaze direction.

The present disclosure primarily focuses on selecting a reference optical prescription for a singular eyeglass lens. It will be understood that eyeglasses typically include two lenses, which may have the same or different optical prescriptions. As such, the techniques described herein may be applied to one or both of the eyeglass lenses of a pair of eyeglasses. In some examples, the characteristics of one lens may be analyzed to select a reference optical prescription for the lens, and then optical parameters of the selected prescription may be applied for both lenses of the pair of eyeglasses. In some examples, both lenses of the eyeglasses may be analyzed separately, and different reference optical prescriptions may be selected for each lens. Furthermore, it will be understood that the techniques discussed herein may also be applied in cases where only one eyeglass lens is present—e.g., a monocular lens.

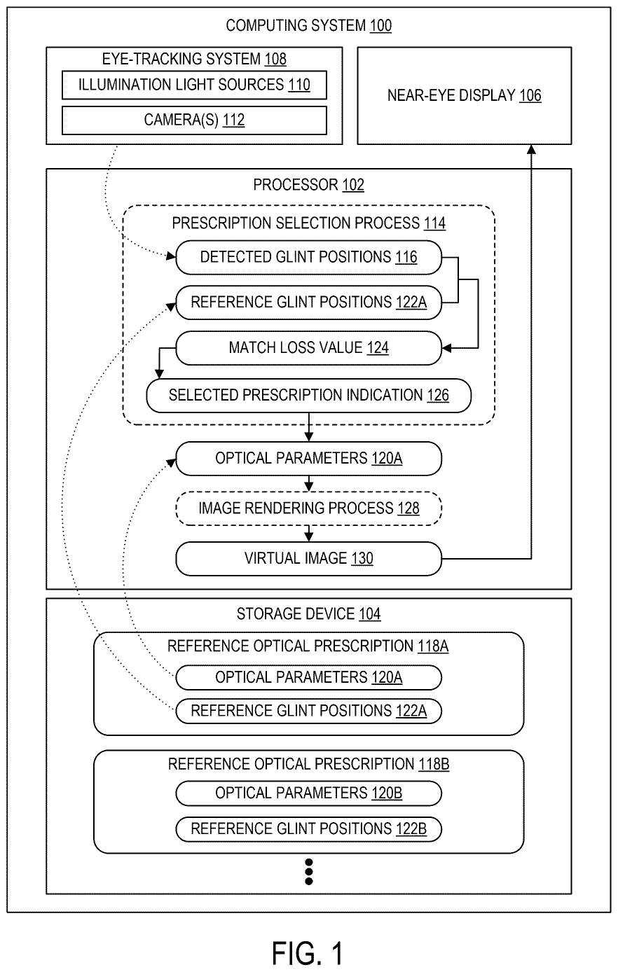

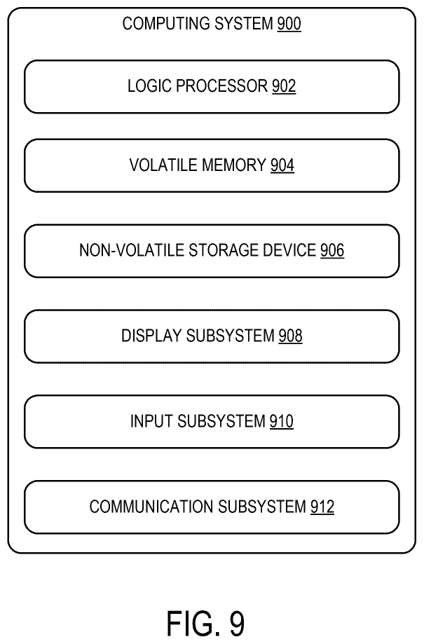

FIG. 1 schematically shows an example computing device 100. Computing device 100 includes a storage device 102 and a processor 104. The storage device holds instructions executable by the processor. As examples, the processor may include one or more central processing units (CPUs), graphics processing units (GPUs), tensor units, application-specific integrated circuits (ASICs), and/or other types of processing devices. The storage device 102 may include volatile memory and/or non-volatile storage. As one non-limiting example, computing device 100 takes the form of an HMD, or another suitable device configured to perform eye-tracking. In general, however, a computing device as described herein may have any suitable capabilities, hardware configuration, and form factor. In some examples, computing device 100 is implemented as computing system 900 described below with respect to FIG. 9.

In this example, the computing system includes a near-eye display that may be used to present rendered virtual images to a user's eyes. The near-eye display may in some cases be at least partially transparent, enabling the user to view virtual imagery while aspects of the real-world remain visible. Alternatively, the near-eye display may be substantially opaque, thereby replacing the user's view of the surrounding real-world environment. As used herein, a “near-eye display” may refer to any suitable visual display system positioned close to the user's eyes to project images directly into their field of view. The near-eye display may include a high-resolution screen, such as an organic light emitting diode (OLED), micro light emitting diode (micro-LED), or liquid crystal display (LCD) panel, coupled with optics to focus and magnify the image for comfortable viewing at close distances. These optics may include lenses, prisms, waveguides, and/or reflective elements, designed to direct and refine the light path to achieve a virtual image perceived at a comfortable distance.

Additionally, in this example, the computing system includes an eye-tracking system 108, which is used to detect the current position of the user's eye pupil and/or the eye's current gaze vector. In this manner, the user may provide user input to the computing system by the direction of their gaze—e.g., to select different interface elements or change their focal point in a virtual environment. To this end, the eye-tracking system includes a plurality of illumination light sources 110, and one or more cameras 112. The illumination light sources may be used to emit illumination light toward the user's eye, and the positions of corresponding glints on the eye may be detected in images captured by the camera(s). This may be input to an eye-tracking process, which estimates the direction of the user's gaze direction based on the positions of the detected glints relative to anatomical features of the eye.

However, according to the techniques discussed herein, output from the camera may additionally or alternatively be used to detect the optical prescription of an eyeglass lens worn by the user. In other words, in this example, the computing device is being used while the user is wearing a pair of eyeglasses, and the lenses have an optical prescription that affects how the user perceives light. For instance, the computing device may take the form of an HMD configured to enable a user to view virtual imagery while continuing to wear their prescription eyeglasses.

In some examples, the position and orientation of the eyeglasses with respect to the eye-tracking system may be predetermined and relatively unchanging over time during use of the HMD. This may include, for instance, mounting the eyeglasses within, and/or otherwise attaching the eyeglasses to, the computing system, to thereby reduce movement of the eyeglasses relative to the eye-tracking system. As will be described in more detail below, in some examples, a tolerance adjustment process may be used to improve the robustness of the prescription detection process to small deviations in the position and/or orientation of the eyeglasses relative to the eye-tracking system.

In the example of FIG. 1, output from the eye-tracking system is input to a prescription selection process 114, which is used to select one of a plurality of predefined reference optical prescriptions as being consistent with the user's eyeglasses. Specifically, as will be described in more detail below, the illumination light sources emit illumination light toward the user's eyeglass lens. The light reflects off the surface of the eyeglass lens to form a plurality of glints, and the positions of these glints are detected via the camera(s) 112. This results in a set of detected glint positions 116, which are characteristic of the user's optical prescription. In other words, when examined under the same conditions (e.g., the same position and orientation relative to the eye-tracking system), different lenses having different optical prescriptions may result in different distributions of detected glint positions. As such, the glint positions detected for a particular lens worn by a user may be compared to other, known glint positions corresponding to predefined reference optical prescriptions, in order to detect the user's prescription.

To illustrate this, in FIG. 1, detected glint positions 116 are compared to various sets of reference glint positions, which are characteristic of various predefined reference optical prescriptions. Computing device 100 includes data pertaining to a plurality of reference optical prescriptions, including at least reference prescriptions 118A and 118B. Each of these are associated with their own sets of respective optical parameters 120A and 120B, which describe optical properties of the prescriptions that are pertinent to eye-tracking and/or virtual image rendering. As non-limiting examples, the optical parameters for the reference optical prescriptions may include a diopter parameter and an astigmatism parameter.

In general, however, “optical parameters” may include any suitable information relating to the optical characteristics of a given lens prescription. Furthermore, the computing device may maintain optical parameters for any suitable number of different reference optical prescriptions, including more than two. In some examples, optical prescriptions can be represented mathematically using methods such as Zernike polynomials, which may provide a convenient way to model refractive and astigmatic properties. However, the present disclosure is not limited to any specific representation mathematical representation of an optical prescription.

Furthermore, in FIG. 1, each reference optical prescription includes a corresponding set of reference glint positions 122A and 122B. These correspond to the expected positions at which glints would be detected, if an eyeglass lens consistent with that prescription were to be used with the computing device. For instance, the reference glint positions may correspond to measured glint positions (and/or hypothetical glint positions) that would result if an eyeglass lens having that optical prescription was placed at the same position and orientation relative to the eye-tracking system as the user's eyeglass lens, and illuminated using illumination light sources 110. Thus, as will be described in more detail below, the detected glint positions may be compared to one or more of the sets of reference glint positions, in order to determine which of the reference optical prescriptions is consistent with the user's optical prescription.

In the example of FIG. 1, the computing system calculates a match loss value 124, which quantifies the degree of difference between the detected glint positions 116, and the reference glint positions 122A of reference optical prescription 118A. As will be described below, the computing system may calculate a plurality of different match loss values, each of which compares the detected glint positions to different sets of reference glint positions corresponding to different reference optical prescriptions. Various criteria may be used to analyze the match loss values calculated for the different reference optical prescriptions, and select one as being the best match for the detected glint positions.

In the example of FIG. 1, the computing system has determined that the detected glint positions 116 are consistent with reference optical prescription 118A. This is reported via a selected prescription indication 126, which indicates that reference optical prescription 118A was selected from among the other reference optical prescriptions as being the best match for the detected glint positions. This may be indicated in any suitable way—e.g., using a unique identifier corresponding to the reference optical prescription.

After selecting the selected optical prescription 118A, the computing system outputs the set of optical parameters 120A corresponding to the selected prescription. These may be used for any suitable downstream computing processes. As used herein, “outputting” the optical parameters may include writing the optical parameters to volatile or non-volatile storage, writing the optical parameters to a file, transmitting the optical parameters over a computer network, providing the optical parameters to a downstream software application, saving the optical parameters to removable data storage, etc.

In this example, the optical parameters are input to an image rendering process 128 (e.g., as a configuration file specifying the set of optical parameters), which accounts for the user's prescription in rendering a virtual image 130 for display via near-eye display 106. For instance, the computing system may distort the virtual image in a manner that makes it appear more accurate and realistic from the user's perspective, when considering how the user's eyeglasses will affect the user's perception of the image. Additionally, or alternatively, the optical parameters may be input to an eye-tracking process, which may use the optical parameters to output a more accurate estimate of the user's gaze direction after accounting for distortion of the illumination light by the user's eyeglass lenses.

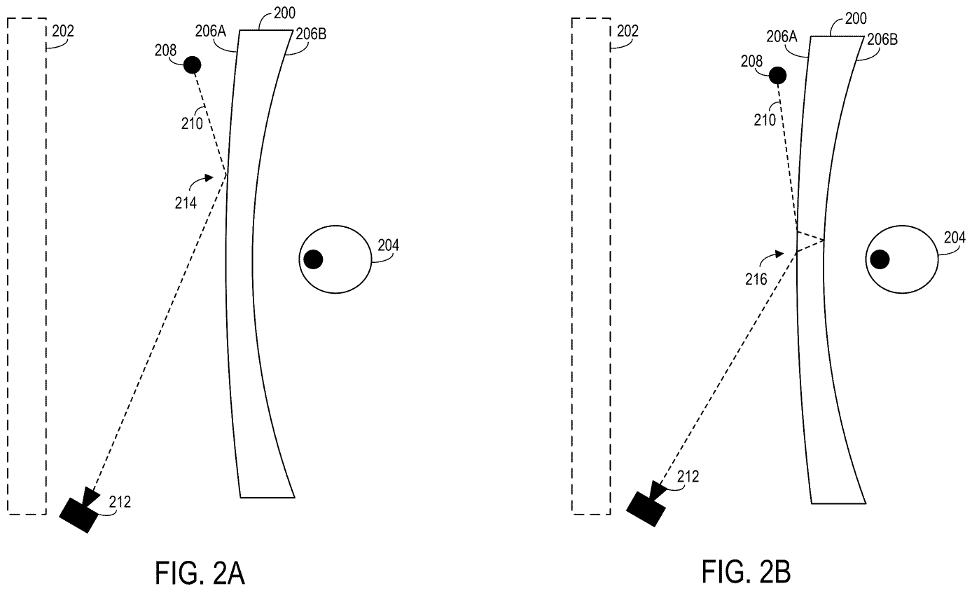

Aspects of the prescription selection process will be described in more detail with respect to FIGS. 2A-7B. Initially, the process of glint detection is schematically illustrated with respect to FIGS. 2A and 2B. Specifically, FIG. 2A schematically represents an example eyeglass lens 200, which is disposed between a near-eye display 202 and a user eye 204. It will be understood that the components and relationships depicted in FIGS. 2A and 2B are highly simplified and presented only as one non-limiting example. For instance, the eyeglass lens may have any suitable shape and size depending on its optical properties, and the specific lens profile depicted in FIGS. 2A and 2B is non-limiting.

As shown, the eyeglass lens includes a surface 206A, which is on a display-facing side of the eyeglass lens. The eyeglass lens additionally includes a second surface 206B on an eye-facing side of the lens. Positions of glints may be detected on one or both of the lens surfaces. FIG. 2A illustrates detection of a glint on the first surface of the lens, while FIG. 2B illustrates detection of a glint on the second surface of the lens.

In FIG. 2A, an illumination light source 208 emits illumination light 210 toward the surface of the eyeglass lens. A portion of the illumination light reflects off the surface of the lens and is detected at a camera 212. This forms a glint 214 at the position of the reflection of the illumination light, which is detectable in images captured by camera 212. Any suitable method may be used for detecting the position of a glint in a camera image. For instance, glint detection algorithms may identify regions of pixels in an image having significantly higher brightness than neighboring pixels—e.g., through a thresholding process. Once isolated, additional criteria-such as shape, size, and position consistency—may be used to confirm that a detected bright spot is a glint rather than noise or an artifact.

As discussed above, the illumination light source and camera may each be components of an eye-tracking system, which may be integrated into an HMD or other type of computing device that performs eye tracking. For instance, the near-eye display, illumination light source 208, and camera 212 may each be components of the same HMD, and the eyeglass lens may be mounted within, or otherwise attached to the HMD, as discussed above. This may beneficially enforce a relatively predefined and unchanging position and orientation of the eyeglass lens relative to the illumination light source and the camera, causing glints to be detected consistently at the same positions for the same optical prescription.

Though only one illumination light source is shown in FIG. 2A, this is non-limiting. In general, any suitable number of one or more illumination light sources may be used to emit illumination light toward the eyeglass lens. In one non-limiting configuration, fourteen different illumination light sources may be used, each configured to emit illumination light toward different locations on the surface of the lens. The illumination light may be emitted with any suitable intensity and wavelength, and in any suitable direction relative to the position of the eyeglass. For instance, the illumination light may be visible light or infrared (IR) light, as examples. In some cases, different illumination light sources may emit illumination light at different wavelengths—e.g., some may emit IR light, while others emit visible light.

Similarly, the camera may have any suitable imaging properties and underlying imaging capabilities. For instance, the camera may be sensitive to visible light, infrared light, and/or other suitable wavelengths. The image sensor of the camera may have any suitable size and pixel resolution. As one non-limiting example, the image sensor may have a resolution of 400×400 pixels. The camera may capture images at any suitable time and at any suitable frame rate.

Furthermore, although only one camera is shown in FIG. 2A, this is non-limiting. Rather, in some examples, two or more different cameras may be used to capture images of the eyeglass lens. The images captured by each camera may be analyzed separately to detect different sets of camera-specific glint positions on the eyeglass lens. In other words, in some examples, the computing system uses a second camera to detect a second set of detected glint positions, which may be analyzed separately from the first set of detected glint positions. These different camera-specific detected glint positions may later be used to calculate different camera-specific match loss values, used in selecting the reference optical prescription, as will be described in more detail below.

FIG. 2B illustrates how, in some cases, glints may be caused by interaction between the illumination light and the opposite surface of the eyeglass lens—e.g., the eye-facing surface 206B. As shown in FIG. 2B, the illumination light source 208 emits illumination light 210 toward the eyeglass lens 200. In this example, the illumination light is refracted into the transparent medium of the eyeglass lens. A portion of the illumination light is reflected by surface 206B, propagates through the lens medium, and exits the lens from surface 206A to be detected at camera 212. In this manner, the illumination light forms another glint 216, which is caused by reflection of the illumination light off the second surface 206B of the eyeglass lens.

As such, for the purposes of the present disclosure, the detected glint positions may include first-surface glint positions (e.g., reflections on first surface 206A), and/or second-surface glint positions (e.g., reflections on second surface 206B). In some examples, the sets of glint positions for different surfaces of the eyeglass lens may be analyzed separately—e.g., they may be used as separate parameters in calculating a match loss value. Alternatively, in some examples, a reference optical prescription may be detected based only on the glints detected for one surface of the eyeglass lens. For instance, one of the two surfaces may result in relatively more change in detected glint positions across different types of prescriptions, and thus may serve as a more useful indicator of the prescription of a given eyeglass lens. Thus, in some examples, computer processing resources may be conserved by only analyzing glint positions for one lens surface—e.g., whichever surface has been shown to better distinguish between different optical prescriptions. For instance, in the example of FIG. 2B, the shape of the second surface 206B may have a greater effect on the resulting glint distribution than the shape of the first surface 206A.

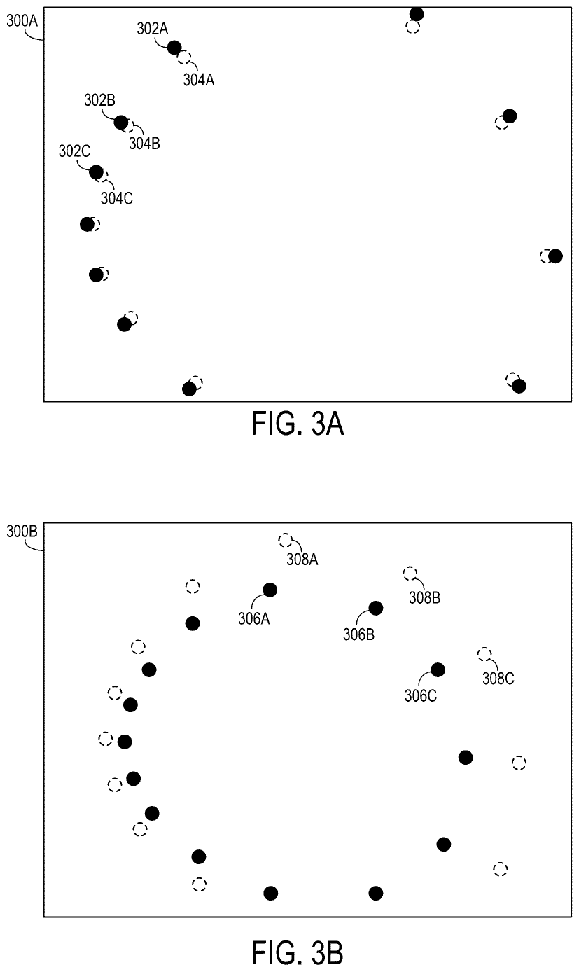

FIGS. 3A and 3B schematically depict different example glint distributions that may be detected through imaging an eyeglass lens as discussed above. FIG. 3A shows a first glint distribution detected for one surface of an eyeglass lens (e.g., surface 206A of eyeglass lens 200), while FIG. 3B shows a second glint distribution detected for another surface of the eyeglass lens (e.g., surface 206B).

With respect to FIG. 3A, a plurality of different detected glint positions are shown as black circles, three of which are labeled as glint positions 302A, 302B, and 302C. These correspond to the detected positions of glints on the first lens surface, caused by illumination light emitted toward the lens by different illumination light sources. A second set of glint positions are shown in dashed lines, three of which are labeled as 304A, 304B, and 304C. These represent hypothetical, alternate positions at which glints would be detected if the eyeglass lens had a different optical prescription, with a different level of diopter power. In other words, the glint positions 304A-C may be considered as reference glint positions corresponding to a reference optical prescription. This illustrates how differences in optical prescription result in different distributions of detected glint positions, enabling detection of a given lens's optical prescription base on its detected set of glint positions. In some implementations, for the display-facing surface of the eyeglass lens, a difference of 150 degrees of diopter power may cause a shift of 1.5-2 pixels (relative to the image sensor) in the positions of each of the detected glints. It will be understood that, in FIGS. 3A and 3B, the differences in position between the detected glints and hypothetical glints is exaggerated for the sake of illustration.

FIG. 3B shows another set of detected glint positions, three of which are labeled as glint positions 306A-C. In this example, the detected glint positions are for the opposite surface of the eyeglass lens—e.g., surface 206B of FIGS. 2A and 2B. Similarly, FIG. 3B shows another set of hypothetical glint positions in dashed lines, corresponding to the expected glint positions for a different optical prescription having a different diopter power. In some implementations, for the eye-facing surface of the eyeglass lens, a difference of 150 degrees of diopter power may result in a shift of 4.5-5 pixels in the positions of each of the detected glints.

FIGS. 3A and 3B both illustrate how changes in a prescription's diopter power result in changes in the detected glint positions. It will be understood that the positions at which glints are detected may also be affected by the astigmatism parameter of an optical prescription, and/or any other optical properties that may vary between different lens prescriptions. In some examples, a difference in 50 degrees of astigmatism may shift the positions of the detected glints by 1.3-1.5 pixels.

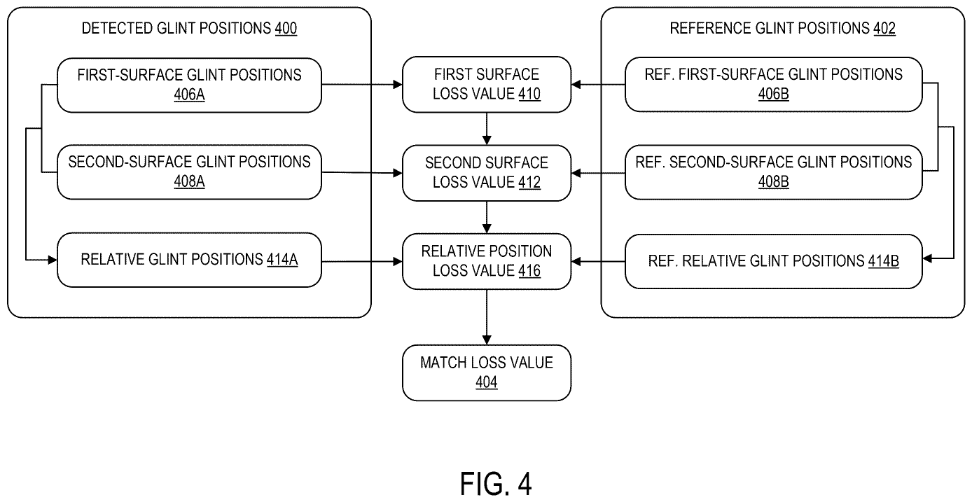

After detecting a set of glint positions for an eyeglass lens, the detected glint positions may be compared to various sets of reference glint positions, corresponding to different reference optical prescriptions, to determine which of the reference optical prescriptions is the best match for the detected glint positions. This is schematically illustrated with respect to FIG. 4, in which a set of detected glint positions is compared to a set of reference glint positions 402. The computing system quantifies the difference between the detected glint positions and reference glint positions with a match loss value 404. In this example, the detected glint positions are compared to one set of reference glint positions, to calculate one match loss value. However, it will be understood that any suitable number of match loss values may be calculated, by comparing the detected glint positions to different sets of reference glint positions for different reference optical prescriptions.

The match loss value may be calculated in any suitable way and take any suitable form. In the example of FIG. 4, the detected glint positions include first-surface glint positions 406A (e.g., a set of glint positions caused by reflections of the illumination light on the first surface of the lens), and second-surface glint positions 408A (e.g., reflections on the opposite surface of the lens). Similarly, the reference glint positions include reference first-surface glint positions 406B, and reference second-surface glint positions 408B.

The first-surface glint positions and reference first-surface glint positions are compared to calculate a first-surface position loss value 410, which quantifies differences between the detected first-surface glint positions and the reference first-surface glint positions. Similarly, the second-surface glint positions and reference second-surface glint positions are compared to calculate a second-surface position loss value 412, which quantifies differences between the detected second-surface glint positions and the reference second-surface glint positions. In this example, the match loss value 404 is calculated based at least in part on the first-surface position loss value 410 and the second-surface position loss value 412.

Additionally, or alternatively, in some examples, the match loss value may be further calculated based at least in part on relative position loss values, which compare detected differences in relative positioning between the first-surface glint positions and the second-surface glint positions. This can account for scenarios where all of the detected glint positions are offset by a similar amount—e.g., due to incorrect positioning of the eyeglass lens relative to the illumination light sources and/or camera. In such cases, the actual positions of the first-surface glints and the second-surface glints may differ from the positions that would be expected for that optical prescription. However, the relative glint positions—e.g., the distance between a particular first-surface glint and a particular second-surface glint—should be relatively unchanged. Thus, consideration of a relative position loss value in calculating the match loss value can account for differences in position and/or orientation of the eyeglass lens relative to the camera and/or light sources.

In the example of FIG. 4, the computing system calculates a set of relative glint positions 414A for the detected glint positions 400. This is done by determining, for one or more of the first-surface glint positions, the difference between those glints and one or more of the second-surface glint positions, to give relative glint position values. These are compared to a set of reference relative glint positions 414B in the reference glint positions, to calculate a relative position loss value 416. This quantifies the difference between the relative glint positions and reference relative glint positions. In FIG. 4, first-surface position loss value 410, second-surface position loss value 412, and the relative position loss value 416 are used together to calculate the match loss value 404.

As one non-limiting example, the match loss value may be calculated according to the below equations:

$$MatchLoss = {PosLoss}_{surfA} + {PosLoss}_{surfB} + P {osLoss}_{surfAB}$$

$${PosLoss}_{surfA} = {\sum }_{i = 1}^{{M}_{A}} {‖ {g}_{Ai}^{detected} - {g}_{Ai}^{reference} ‖}^{2}$$

$${PosLoss}_{surfB} = {\sum }_{i = 1}^{{M}_{B}} {‖ {g}_{Bi}^{detected} - {g}_{Bi}^{reference} ‖}^{2}$$

$${PosLoss}_{surfAB} = {\sum }_{i = 1}^{{M}_{A B}} {‖ {g}_{ABi}^{detected} - {g}_{ABi}^{reference} ‖}^{2}$$

In these equations, A and B respectively refer to the first and second surfaces of the eyeglass lens, MatchLoss refers to the match loss value, PosLoss_{surfA} and PosLOSS_{surfB} refer to the first-surface and second-surface position loss values, PosLoss_{surfAB} is the relative position loss value, M_{A} and M_{B} refer to the number of glints detected on the first and second surfaces, M_{AB} refers to the number of detected glints on both the first and second surfaces, and g is the detected glint position expressed as a two-dimensional coordinate (e.g., a pixel position in a digital image).

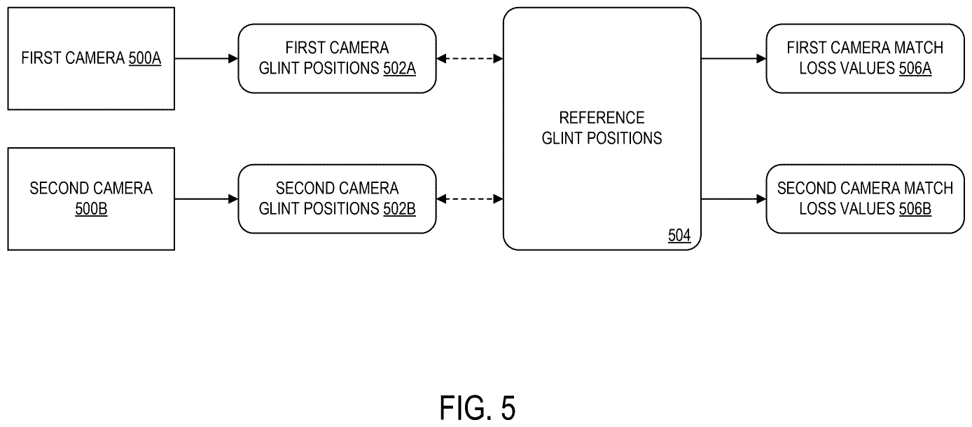

The present disclosure has thus far primarily focused on scenarios where one camera is used to detect one set of glint positions for the eyeglass lens. However, as indicated above, the computing system may in some cases include two or more cameras, which may be used to detect two or more sets of glint positions for the same eyeglass lens. This scenario is schematically illustrated with respect to FIG. 5, where the computing system includes at least two cameras 500A and 500B. The cameras are each used to capture images depicting an eyeglass lens illuminated by a plurality of illumination light sources, to detect two sets of detected glint positions 502A and 502B. Each camera-specific set of detected glint positions is compared separately with the reference glint positions 504 to calculate different respective match loss values. In other words, in this example, a plurality of first-camera match loss values 506 are calculated for the first-camera detected glint positions 502A. A second plurality of match loss values 506B is calculated for the second-camera detected glint positions 502B.

In some examples, the computing system may iteratively calculate two or more different match loss values for the same set of detected glint positions. This may be done to improve the tolerance of the prescription detection process to small deviations in the position and/or orientation of the eyeglass lens. For instance, the computing system may calculate an initial set of match loss values by comparing the detected glint positions to different sets of reference glint positions. However, in some cases, none of these calculated match values may satisfy a match threshold indicative of a matching reference optical prescription. Thus, the computing system may apply tilt and/or translation adjustments to the set of detected glint positions, and then recalculate the match loss values, in an attempt to reduce one or more of the match loss values and find a matching reference optical prescription. In some cases, this may be performed iteratively—e.g., additional tilt and/or translation adjustments may be applied to the detected glint positions until a match loss value is calculated that satisfies the match threshold.

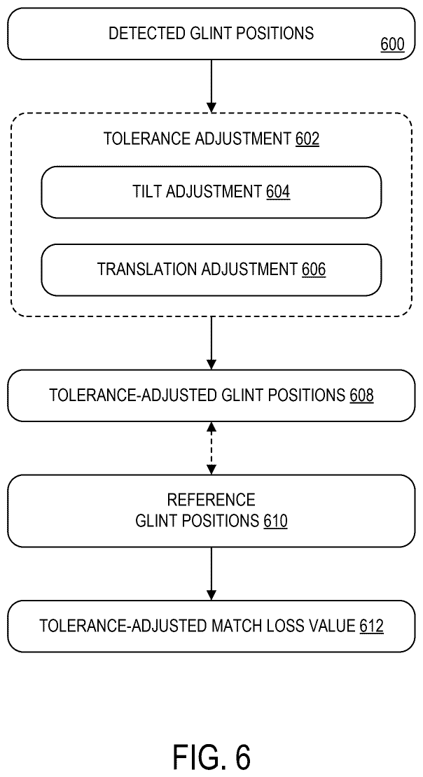

This is schematically illustrated with respect to FIG. 6, showing a set of detected glint positions 600, which are input into a tolerance adjustment process 602. This includes applying a tilt adjustment 604 and a translation adjustment 606 to the detected glint positions, to output a set of tolerance-adjusted glint positions 608. The tilt adjustment may include transforming the detected glint positions using rotational matrices to simulate angular shifts caused by lens tilt. This accounts for changes in the apparent position of glints due to the lens rotating about one or more of its rotational axes. The translation adjustment may include applying uniform offsets to the glint positions to account for lens displacement along the x, y, or z axes. This models how the lens shifting in space alters the relative positions of the glints.

The changes applied during the tilt and translation adjustments may have any suitable magnitude. As one non-limiting example, the positions of the detected glints may be shifted by an amount that ranges between 1-5 pixels during tilt and/or translation adjustment. In other implementations, other suitable ranges may be used, based on the geometry of the optical system, the resolution of the camera sensor, and/or other factors.

After the tolerance adjustment process, the tolerance-adjusted glint positions 608 are compared to sets of reference glint positions 610, which correspond to two or more different reference optical prescriptions, to calculate corresponding sets of tolerance-adjusted match loss values 612. In the event that one or more of these match loss values satisfies a match threshold, then a corresponding reference optical prescription may be selected as the best match for the detected glint positions. However, if none of the tolerance-adjusted match loss values satisfy the match condition, then the tolerance adjustment may be performed iteratively. In other words, additional or alternative adjustments may be applied to the detected glint positions, over one or more subsequent iteration cycles. This may continue until a match loss value is calculated that satisfies the match threshold, or until another exit condition is met (e.g., a threshold number of iteration cycles elapsing with no matching prescriptions).

In some cases, if a matching reference optical prescription is detected after tilt and/or translation adjustments are applied, then the nature of the adjustments may be used to estimate tilt and translation parameters for the eyeglass lens. For instance, based on the number of pixels that each detected glint position was shifted during a translation adjustment, the computing system may estimate the amount by which the eyeglass lens is translated from its ideal reference position. Similarly, the computing system may estimate the amount of angular tilt by which the eyeglass lens differs from its ideal reference orientation. These translation and tilt estimates may be estimated in any suitable way based on the geometry of the optical system, and the magnitude of the tilt and translation adjustments. Furthermore, the translation and tilt estimates may be included in the set of optical parameters later output for the selected optical prescription.

In any case, as match loss values are calculated, they may be compared to a match threshold in order to determine if that match loss value represents a successful match between the detected glint positions and one of the reference optical prescriptions. For instance, relatively smaller match loss values may be indicative of greater similarity between a set of detected glint positions and a set of reference glint positions. Thus, in the event that a calculated match loss value is less than a match threshold, a reference optical prescription corresponding to that calculated match loss value may be selected as the best match for the detected glint positions.

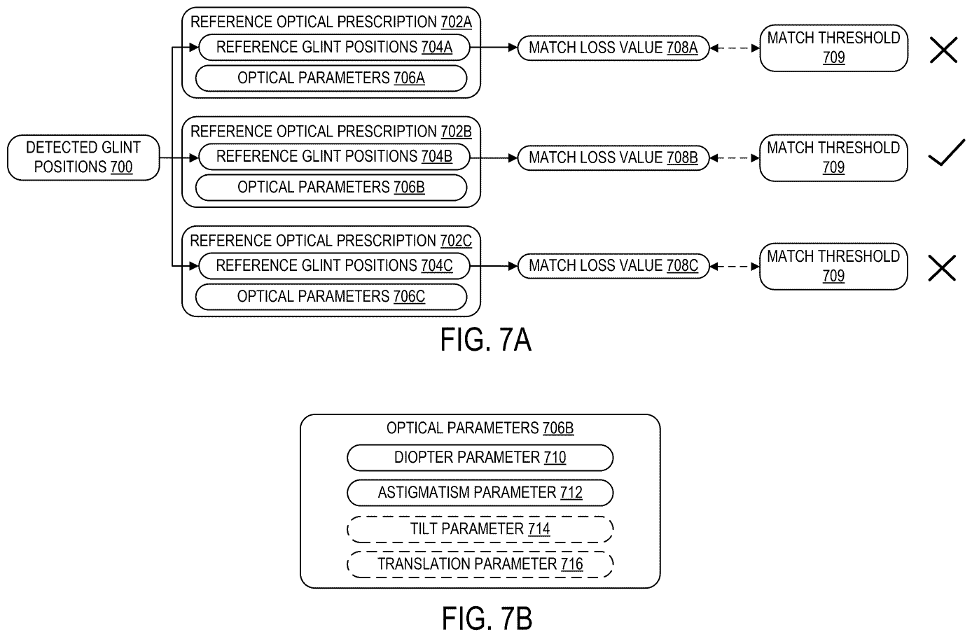

This is schematically illustrated with respect to FIGS. 7A and 7B. FIG. 7A shows a set of detected glint positions 700, which is compared to a plurality of different reference optical prescriptions 702A, 702B, and 702C as discussed above. Each reference optical prescription includes its own set of optical parameters 706A/B/C. The detected glint positions are compared to different sets of reference glint positions 704A, 704B, and 704C that are characteristic of each of the reference optical prescriptions. Differences between the detected glint positions and the reference glint positions are quantified by calculating match loss values 708A, 708B, and 708C. These are each compared to a match threshold 709 to determine if the match loss values are less than the threshold, and therefore consistent with a successful match between the detected glint positions and the reference glint position for that match loss value. In the example of FIG. 7A, match loss value 708B does satisfy the match threshold, and therefore is selected as the selected reference optical prescription.

Notably, the detected glint positions need not always be compared to every set of reference glint positions for the reference optical prescriptions. For instance, in some cases, the set of reference optical prescriptions may be limited to the first N reference optical prescriptions, where N can be any suitable value depending on the implementation—e.g., the amount of available processing resources. The computing system may attempt to identify the best reference optical prescription from among the N optical prescriptions. In the event that none of the N reference optical prescriptions are a match, then in some cases the detected glint positions may be compared to additional reference optical prescriptions. Alternatively, the computing system may select the best match from among the N optical prescriptions, even if none of them satisfy the match threshold.

In any case, according to the techniques described herein, a reference optical prescription is selected and a corresponding set of optical parameters are output for downstream processing—e.g., for eye-tracking and/or virtual image rendering. FIG. 7B schematically represents data included in the optical parameters 706B corresponding to the selected reference optical prescription. Specifically, the optical parameters include a diopter parameter 710 and an astigmatism parameter 712 for the selected reference optical prescription. In some examples, in cases where tilt and/or translation adjustment are applied, then the computing system may additionally include tilt and/or translation optical parameters in the set of optical parameters output for the selected reference prescription—e.g., tilt parameter 714 and translation parameter 716—as discussed above.

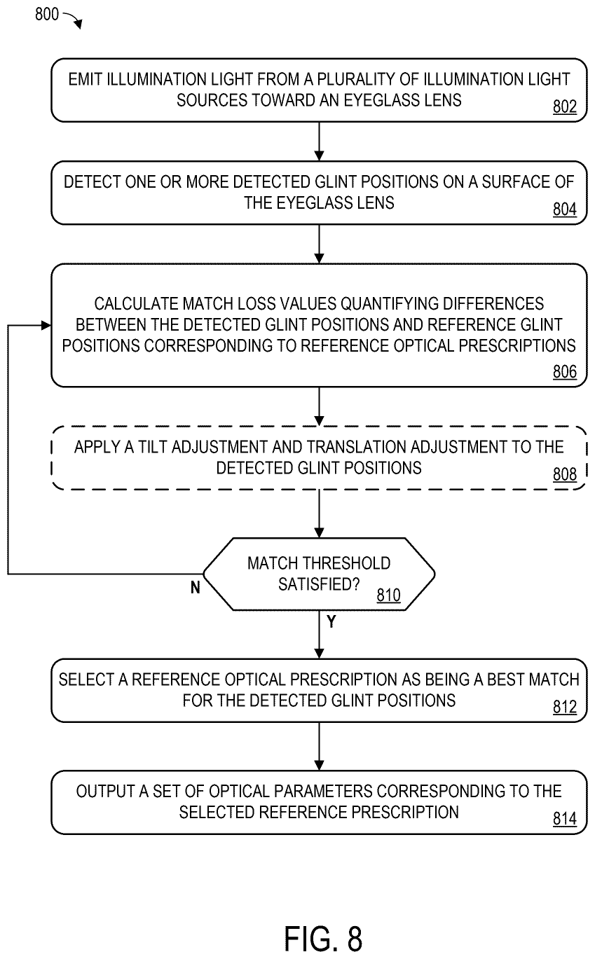

FIG. 8 illustrates an example method 800 for automatically detecting the optical prescription of an eyeglass lens. Steps of method 800 may be initiated, terminated, and/or repeated at any suitable time, and in response to any suitable condition. Method 800 may be performed by any suitable computing system of one or more computing devices. Any computing device implementing steps of method 800 may have any suitable capabilities, hardware configuration, and form factor. In some examples, method 800 may be implemented by computing system 900 described below with respect to FIG. 9.

At 802, method 800 includes emitting illumination light from a plurality of illumination light sources toward an eyeglass lens. At 804, the method includes detecting one or more detected glint positions on a surface of the eyeglass lens. This may be done as described above with respect to FIGS. 2A and 2B—e.g., positions of one or more glints may be detected on one or more surfaces of the eyeglass lens, by illuminating the lens with a plurality of sources of illumination light.

At 806, method 800 includes calculating match loss values quantifying differences between the detected glint positions and reference glint positions corresponding to the reference optical prescriptions. This may be done in any suitable way. For instance, as described above with respect to FIG. 4, the match loss values may be calculated based on first-surface and second-surface position loss values, and/or relative position loss values.

At 808, method 800 optionally includes applying a tilt adjustment and a translation adjustment to the detected glint positions. This may account for differences between the position and orientation of the eyeglass lens compared to its ideal reference position and orientation, and result in calculation of new tolerance-adjusted match loss values. One or more of these tolerance-adjusted match loss values may be lower than prior match loss values calculated before the tolerance and tilt adjustments, representing a better match between the detected glint positions and one or more of the reference optical prescriptions.

At 810, method 800 includes determining whether any of the calculated match loss values satisfy a match threshold. The match threshold may have any suitable value depending on the implementation—e.g., to balance the sensitivity of the detection process against the risk of false positive detections. If no match loss values satisfy the match threshold, the method proceeds to 806 for calculation of additional match loss values (e.g., based on other reference optical prescriptions), and/or additional tilt and translation adjustment. If a match loss value does satisfy the match threshold, then the method proceeds to 812, where the computing system selected a reference optical prescription as being the best match for the detected glint positions. At 814, the method includes outputting a set of optical parameters corresponding to the selected reference optical prescription.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 may embody the computer device 10 described above and illustrated in FIG. 2. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 904, and a non-volatile storage device 906. Computing system 900 may optionally include a display subsystem 908, input subsystem 910, communication subsystem 912, and/or other components not shown in FIG. 9.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed—e.g., to hold different data.

Non-volatile storage device 906 may include physical devices that are removable and/or built-in. Non-volatile storage device 906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

The following paragraphs provide additional description of the subject matter of the present disclosure:

In an example, a method for automatically detecting an optical prescription of an eyeglass lens comprises: emitting illumination light from a plurality of illumination light sources toward an eyeglass lens; detecting, via a camera, detected glint positions of one or more glints on a surface of the eyeglass lens caused by the illumination light; calculating a plurality of match loss values quantifying differences between the detected glint positions on the surface of the eyeglass lens, and reference glint positions that correspond to a plurality of different reference optical prescriptions; based on the match loss values, selecting a selected reference optical prescription of the plurality of different reference optical prescriptions as being a best match for the detected glint positions; and outputting a set of one or more optical parameters corresponding to the selected reference optical prescription. In this example or any other example, the surface is a first surface of the eyeglass lens and the detected glint positions are first-surface glint positions, and the method further comprises detecting second-surface glint positions on a second surface of the eyeglass lens, and the reference glint positions include reference first-surface glint positions and reference second-surface glint positions. In this example or any other example, the match loss values are calculated based at least in part on first-surface position loss values and second-surface position loss values, wherein the first-surface position loss values quantify differences between the first-surface glint positions and the reference first-surface glint positions, and wherein the second-surface position loss values quantify differences between the second-surface detected glint positions and the reference second-surface glint positions. In this example or any other example, the match loss values are further calculated based at least in part on relative position loss values, which compare detected differences in relative positioning between the first-surface glint positions and the second-surface glint positions, to reference differences in relative positioning between the reference first-surface and the second-surface glint positions. In this example or any other example, the selected reference optical prescription is selected based at least in part on a match loss value calculated for the selected reference optical prescription being less than a match threshold. In this example or any other example, the camera is a first camera, and the method further comprises detecting a second set of detected glint positions via a second camera, wherein a second plurality of match loss values are calculated for the second set of detected glint positions, and wherein the selected reference optical prescription is further selected based at least in part on the second plurality of match loss values. In this example or any other example, the method further comprises, prior to selecting the selected reference optical prescription, applying a tilt adjustment and a translation adjustment to the detected glint positions to reduce one or more match loss values of the plurality of match loss values. In this example or any other example, the method further comprises iteratively applying additional tilt adjustments and translation adjustments to the detected glint positions until a match loss value of the plurality of match loss values is less than a match threshold. In this example or any other example, the set of one or more optical parameters for the selected reference optical prescription includes a diopter parameter and an astigmatism parameter. In this example or any other example, the illumination light sources and camera are components of an eye-tracking system of a head-mounted display device (HMD).

In an example, a computing system comprises: a processor; and a storage device holding instructions executable by the processor to: emit illumination light from a plurality of illumination light sources toward an eyeglass lens; detect, via a camera, detected glint positions of one or more glints on a surface of the eyeglass lens caused by the illumination light; calculate a plurality of match loss values quantifying differences between the detected glint positions on the surface of the eyeglass lens, and reference glint positions that correspond to a plurality of different reference optical prescriptions; based on the match loss values, select a selected reference optical prescription of the plurality of different reference optical prescriptions as being a best match for the detected glint positions; and output a set of one or more optical parameters corresponding to the selected reference optical prescription. In this example or any other example, the surface is a first surface of the eyeglass lens and the detected glint positions are first-surface glint positions, wherein the method further comprises detecting second-surface glint positions on a second surface of the eyeglass lens, and wherein the reference glint positions include reference first-surface glint positions and reference second-surface glint positions. In this example or any other example, the match loss values are calculated based at least in part on first-surface position loss values and second-surface position loss values, wherein the first-surface position loss values quantify differences between the first-surface glint positions and the reference first-surface glint positions, and wherein the second-surface position loss values quantify differences between the second-surface detected glint positions and the reference second-surface glint positions. In this example or any other example, the match loss values are further calculated based at least in part on relative position loss values, which compare detected differences in relative positioning between the first-surface glint positions and the second-surface glint positions, to reference differences in relative positioning between the reference first-surface and the second-surface glint positions. In this example or any other example, the selected reference optical prescription is selected based at least in part on a match loss value calculated for the selected reference optical prescription being less than a match threshold. In this example or any other example, the camera is a first camera, and the method further comprises detecting a second set of detected glint positions via a second camera, wherein a second plurality of match loss values are calculated for the second set of detected glint positions, and wherein the selected reference optical prescription is further selected based at least in part on the second plurality of match loss values. In this example or any other example, the instructions are further executable to, prior to selecting the selected reference optical prescription, apply a tilt adjustment and a translation adjustment to the detected glint positions to reduce one or more match loss values of the plurality of match loss values. In this example or any other example, the instructions are further executable to iteratively apply additional tilt adjustments and translation adjustments to the detected glint positions until a match loss value of the plurality of match loss values is less than a match threshold. In this example or any other example, the set of one or more optical parameters for the selected reference optical prescription includes a diopter parameter and an astigmatism parameter.

In an example, a method for automatically detecting an optical prescription of an eyeglass lens at a head-mounted display device (HMD) comprises: emitting illumination light from a plurality of illumination light sources of an eye-tracking system toward an eyeglass lens; detecting, via a camera of the eye-tracking system, detected glint positions of one or more glints on a surface of the eyeglass lens caused by the illumination light; calculating a plurality of match loss values quantifying differences between the detected glint positions on the surface of the eyeglass lens, and reference glint positions that correspond to a plurality of different reference optical prescriptions; applying a tilt adjustment and a translation adjustment to the detected glint positions to reduce one or more match loss values of the plurality of match loss values; based on the match loss values, selecting a selected reference optical prescription of the plurality of different reference optical prescriptions as being a best match for the detected glint positions; and outputting a set of one or more optical parameters corresponding to the selected reference optical prescription.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for automatically detecting an optical prescription of an eyeglass lens, the method comprising:
emitting illumination light from a plurality of illumination light sources toward an eyeglass lens;
detecting, via a camera, detected glint positions of one or more glints on a surface of the eyeglass lens caused by the illumination light;
calculating a plurality of match loss values quantifying differences between the detected glint positions on the surface of the eyeglass lens, and reference glint positions that correspond to a plurality of different reference optical prescriptions;
based on the match loss values, selecting a selected reference optical prescription of the plurality of different reference optical prescriptions as being a best match for the detected glint positions; and
outputting a set of one or more optical parameters corresponding to the selected reference optical prescription.

2. The method of claim 1, wherein the surface is a first surface of the eyeglass lens and the detected glint positions are first-surface glint positions, wherein the method further comprises detecting second-surface glint positions on a second surface of the eyeglass lens, and wherein the reference glint positions include reference first-surface glint positions and reference second-surface glint positions.

3. The method of claim 2, wherein the match loss values are calculated based at least in part on first-surface position loss values and second-surface position loss values, wherein the first-surface position loss values quantify differences between the first-surface glint positions and the reference first-surface glint positions, and wherein the second-surface position loss values quantify differences between the second-surface detected glint positions and the reference second-surface glint positions.

4. The method of claim 3, wherein the match loss values are further calculated based at least in part on relative position loss values, which compare detected differences in relative positioning between the first-surface glint positions and the second-surface glint positions, to reference differences in relative positioning between the reference first-surface and the second-surface glint positions.

5. The method of claim 1, wherein the selected reference optical prescription is selected based at least in part on a match loss value calculated for the selected reference optical prescription being less than a match threshold.

6. The method of claim 1, wherein the camera is a first camera, and the method further comprises detecting a second set of detected glint positions via a second camera, wherein a second plurality of match loss values are calculated for the second set of detected glint positions, and wherein the selected reference optical prescription is further selected based at least in part on the second plurality of match loss values.

7. The method of claim 1, further comprising, prior to selecting the selected reference optical prescription, applying a tilt adjustment and a translation adjustment to the detected glint positions to reduce one or more match loss values of the plurality of match loss values.

8. The method of claim 7, further comprising iteratively applying additional tilt adjustments and translation adjustments to the detected glint positions until a match loss value of the plurality of match loss values is less than a match threshold.

9. The method of claim 1, wherein the set of one or more optical parameters for the selected reference optical prescription includes a diopter parameter and an astigmatism parameter.

10. The method of claim 1, wherein the illumination light sources and camera are components of an eye-tracking system of a head-mounted display device (HMD).

11. A computing system, comprising:
a processor; and
a storage device holding instructions executable by the processor to:
emit illumination light from a plurality of illumination light sources toward an eyeglass lens;
detect, via a camera, detected glint positions of one or more glints on a surface of the eyeglass lens caused by the illumination light;
calculate a plurality of match loss values quantifying differences between the detected glint positions on the surface of the eyeglass lens, and reference glint positions that correspond to a plurality of different reference optical prescriptions;
based on the match loss values, select a selected reference optical prescription of the plurality of different reference optical prescriptions as being a best match for the detected glint positions; and
output a set of one or more optical parameters corresponding to the selected reference optical prescription.

12. The computing system of claim 11, wherein the surface is a first surface of the eyeglass lens and the detected glint positions are first-surface glint positions, wherein the method further comprises detecting second-surface glint positions on a second surface of the eyeglass lens, and wherein the reference glint positions include reference first-surface glint positions and reference second-surface glint positions.

13. The computing system of claim 12, wherein the match loss values are calculated based at least in part on first-surface position loss values and second-surface position loss values, wherein the first-surface position loss values quantify differences between the first-surface glint positions and the reference first-surface glint positions, and wherein the second-surface position loss values quantify differences between the second-surface detected glint positions and the reference second-surface glint positions.

14. The computing system of claim 13, wherein the match loss values are further calculated based at least in part on relative position loss values, which compare detected differences in relative positioning between the first-surface glint positions and the second-surface glint positions, to reference differences in relative positioning between the reference first-surface and the second-surface glint positions.

15. The computing system of claim 11, wherein the selected reference optical prescription is selected based at least in part on a match loss value calculated for the selected reference optical prescription being less than a match threshold.

16. The computing system of claim 11, wherein the camera is a first camera, and the method further comprises detecting a second set of detected glint positions via a second camera, wherein a second plurality of match loss values are calculated for the second set of detected glint positions, and wherein the selected reference optical prescription is further selected based at least in part on the second plurality of match loss values.

17. The computing system of claim 11, wherein the instructions are further executable to, prior to selecting the selected reference optical prescription, apply a tilt adjustment and a translation adjustment to the detected glint positions to reduce one or more match loss values of the plurality of match loss values.

18. The computing system of claim 17, wherein the instructions are further executable to iteratively apply additional tilt adjustments and translation adjustments to the detected glint positions until a match loss value of the plurality of match loss values is less than a match threshold.

19. The computing system of claim 11, wherein the set of one or more optical parameters for the selected reference optical prescription includes a diopter parameter and an astigmatism parameter.

20. A method for automatically detecting an optical prescription of an eyeglass lens at a head-mounted display device (HMD), the method comprising:
emitting illumination light from a plurality of illumination light sources of an eye-tracking system toward an eyeglass lens;
detecting, via a camera of the eye-tracking system, detected glint positions of one or more glints on a surface of the eyeglass lens caused by the illumination light;
calculating a plurality of match loss values quantifying differences between the detected glint positions on the surface of the eyeglass lens, and reference glint positions that correspond to a plurality of different reference optical prescriptions;
applying a tilt adjustment and a translation adjustment to the detected glint positions to reduce one or more match loss values of the plurality of match loss values;
based on the match loss values, selecting a selected reference optical prescription of the plurality of different reference optical prescriptions as being a best match for the detected glint positions; and
outputting a set of one or more optical parameters corresponding to the selected reference optical prescription.
